(19) United States
(12) Patent Application Publication
(10) Pub. No.: US 2019/0066625 A1
(43) Pub. Date: Feb. 28, 2019

(54) ADAPTER

(71) Applicant: SHENZHEN LIDACHENG TECHNOLOGY CO., LTD., Shenzhen Guangdong (CN)

(72) Inventor: Jincheng WU, Shenzhen, Guangdong (CN)

(21) Appl. No.: 15/555,796

(22) PCT Filed: Aug. 24, 2017
(86) PCT No.: PCT/CN2017/098799

§ 371 Date: Sep. 5, 2017

(51) Int. Cl. G09G 5/00; H01R 13/66; H01R 33/90; G06F 13/42

(52) U.S. Cl. CPC G09G 5/006; H01R 13/6683; H01R 33/90; H02J 7/0052; G09G 2370/12; G09G 2370/22; G06F 13/4282

(57) ABSTRACT

The present application pertains to the technical field of electronics and discloses an adapter, which is configured to connect a host with a display device, and includes: a charging interface, a power module, a HUB interface, a control module, a host interface, and a HDMI module; the charging interface is connected with the power module, the charging interface is capable of externally connecting with a power adapter to charge the host; the HUB interface is connected with the host interface and an input/output device; the host interface is configured to externally connect with the host; and the HDMI module includes a video processing chip and an HDMI interface, and the control module controls display states of the host and the display device according to a connection state of the display device.

### TECHNICAL FIELD

The present application pertains to the technical field of electronics, and more particularly relates to an adapter.

### BACKGROUND

With the development of the technology, existing gaming devices provide more and more kinds of games and have more and more powerful functions, thereby possess strong entertainment and interactivity.

With the popularization of the handheld games, more and more co-products of handheld games have appeared on the market. Because the handheld games are played based on handheld gaming machines, while screens of the handheld gaming machines are relatively small, the relatively small display interfaces of the games are resulted in and the game experiences of the handheld games are weakened; in addition, the electric power of the handheld gaming machines are quickly consumed, after a long-term use, it requires to charge the handheld gaming machines by using compatible chargers at the same time when the handheld gaming machines are used.

An adapter in the prior art can realize switching between the small screen of the host and the large screen of the externally connected display device to display the game interface of the host on the screen of the externally connected display device, and a handle, a keyboard, etc. can be cooperatively used. However, with respect to the adapter in the prior art, once the host is connected in the adapter, a black screen occurs on the small screen of the host, and no picture is output on the small screen of the host; when an externally connected display device is inserted, a video signal of the host is output to the externally connected display device for display; and when the externally connected display device is not inserted, the host still remains in the black screen state. Besides, the structure of the adapter in the prior art will cover a rear casing and a main screen of the inserted host, the screen of the host is prone to be scraped during the insertion of the host into the adapter, and poor heat dissipation of the host is resulted in during the use thereof.

### SUMMARY

Conventional technical solutions have the problems that: once the host is connected in the adapter, the picture output of the host is stopped; the interaction mode is simple, the heat dissipation effect is poor, and the user experience is poor.

It is an objective of the present application to provide an adapter, which aims at solving the problems existing in the conventional technical solution that: once the host is connected in the adapter, the picture output of the host is stopped; the interaction mode is simple, the heat dissipation effect is poor, and the user experience is poor.

An embodiment of the present application is realized as follows: an adapter, which is configured to connect a host with a display device and comprises a charging interface, a power module configured to supply power, a HUB interface, a control module, a host interface, and a high definition multimedia interface (HDMI) module. The charging interface is connected with the power module, the charging interface is capable of externally connecting with a power adapter to charge the host; the HUB interface is connected with the host interface and an input/output device; the host interface is configured to externally connect with the host; and the HDMI module comprises a video processing chip and an HDMI interface, the video processing chip is connected with the control module, the HDMI interface, and the host interface; the HDMI interface is connected with the display device, and the control module controls display states of the host and the display device according to a connection state of the display device.

Further, the video processing chip comprises a device insertion detection pin configured to detect whether the display device is connected in the HDMI interface, the device insertion detection pin is connected with the HDMI interface and the control module, the control module controls the display states of the host and the display device according to a state of the device insertion detection pin.

Further, a first resistance and a second resistance are connected between the video processing chip and the control module; and a first end of the first resistance is connected with the device insertion detection pin and the HDMI interface, a second end of the first resistance is connected with a first end of the second resistance, a public connection end of the first resistance and the second resistance is connected with the control module, and a second end of the second resistance is grounded.

Further, the charging interface is a Type-C interface.

Further, the control module is a microcontroller.

Further, a power switch is connected between the power module and the host interface, the power switch controls the power module to energize/deenergize the host upon receiving a level signal output from the control module.

Further the adapter further comprises a HUB chip, the HUB chip is connected with the power module, the control module, and the HUB interface.

Further, the HUB interface comprises a USB 2.0 interface and/or a USB 3.0 interface.

Further, the input/output device comprises a handle, a keyboard, and a network card.

Further, the display device comprises a displayer, a television set, or a projector.

By adopting the above-described adapter, the game interface of the host can be output to the display device via an HDMI line to realize the display of the game interface on the large screen, so that the handheld games are no longer limited on the interface of the handled gaming machine; besides, externally connected devices, such as the handle, the keyboard, and so on, are connected on the adapter to combine the conventional gaming devices with the handheld games, the handled gaming machine is controlled, for example, by the handle, and at the same time the function of charging the host is realized. In addition, in the absence of the externally connected display device, when the host is inserted in the adapter, the screen of the host still output pictures, at this moment, the host is fixed on the adapter, the adapter functions as a charging stand, a certain angle is formed between the screen of the host and the horizontal plan, at the same time when the host is charged, the user can use the handle compatible with the host to perform wireless operations on the game of the host or use the handle or keyboard that is externally connected via the HUB interface to operate the game of the host, which greatly improves the user experience.

### BRIEF DESCRIPTION OF THE DRAWINGS

FIG. 1 is a block diagram of a whole circuit structure of an adapter of the present application;

FIG. 2 is an exemplary circuit principle diagram of a photo diode (PD) chip in the block diagram of the circuit structure of the adapter of FIG. 1;

FIG. 3 is an exemplary circuit principle diagram of a control module in the block diagram of the circuit structure of the adapter of FIG. 1;

FIG. 4 is an exemplary circuit principle diagram of a video processing chip in the block diagram of the circuit structure of the adapter of FIG. 1;

FIG. 5 is an exemplary circuit principle diagram of a HUB chip in the block diagram of the circuit structure of the adapter of FIG. 1;

FIG. 6 is an exemplary diagram of an HDMI interface in the block diagram of the circuit structure of the adapter of FIG. 1; and

FIG. 7 is an exemplary diagram of a dividing resistor between the control module and the video processing chip in the block diagram of the circuit structure of the adapter of FIG. 1.

### DETAILED DESCRIPTION OF THE EMBODIMENTS

In order to make the purposes, technical solutions, and advantages of the present application be clearer and more understandable, the present application will be further described in detail hereinafter with reference to the accompanying drawings and embodiments. It should be understood that the embodiments described herein are only intended to illustrate but not to limit the present application.

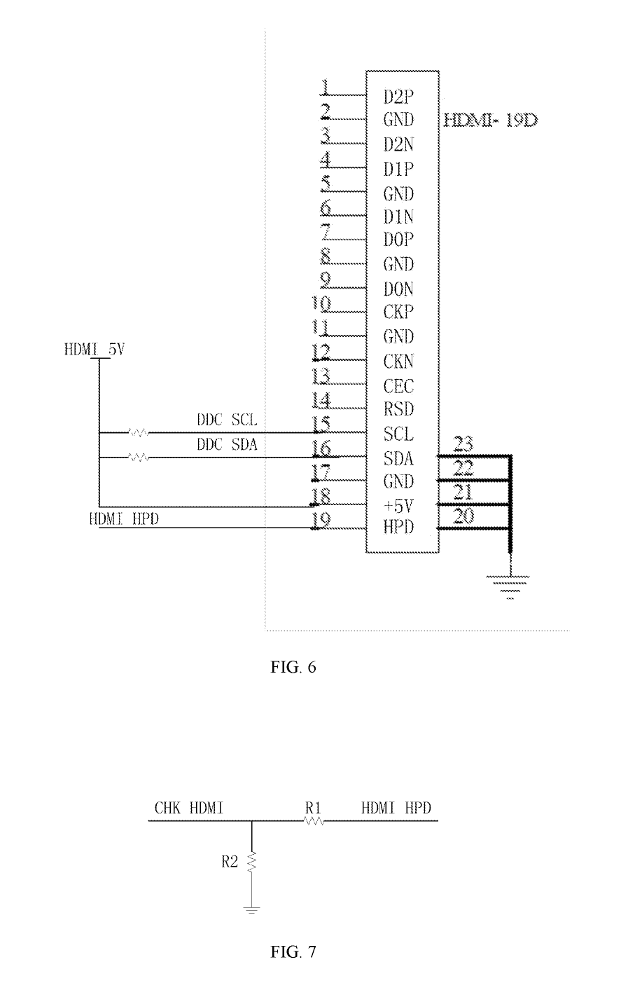

As shown in FIGS. 1-7, an adapter 100 in a preferred embodiment of the present application is connected between a host 200 and a display device 300 and is integrated with charging, data transmission, and video output as a whole, thereby realizes seamlessly switch between a small screen of the host 200 and a large screen of the display device 300, and in the absence of the externally connected display device 300, when the host 200 is inserted in the adapter 100, the screen of the host 200 still outputs images.

The adapter 100 comprises a charging interface 101, a power module 102, a HUB interface 103, a control module 104, a host interface 105, and a high definition multimedia interface (HDMI) module 106.

The charging interface 101 is a Type-C interface, the charging interface 101 is connected with the power module 102, and the charging interface 101 can be externally connected with a power adapter 400 to charge the host 200; the control module 104 is a microcontroller provided with a reset and upgraded input/output (I/O) port; the power module 102 is connected with the control module 104, an HUB chip 108, and a video processing chip to supply power to the control module 104, the HUB chip 108, and the video processing chip (not shown in the figures), when the host 200 is inserted in the host interface 105, the power module 102 charges the host 200; the HUB interface 103 is connected with the host interface 105 and an input/output device 500; the host interface 105 is externally connected with the host 200; the HDMI module 106 comprises the video processing chip and an HDMI interface, the video processing chip is connected with the control module 104, the HDMI interface, and the host interface 105, the HDMI interface is connected with the display device 300, and the control module 104 controls display states of the host 200 and the display device 300 according to a connection state of the display device 300.

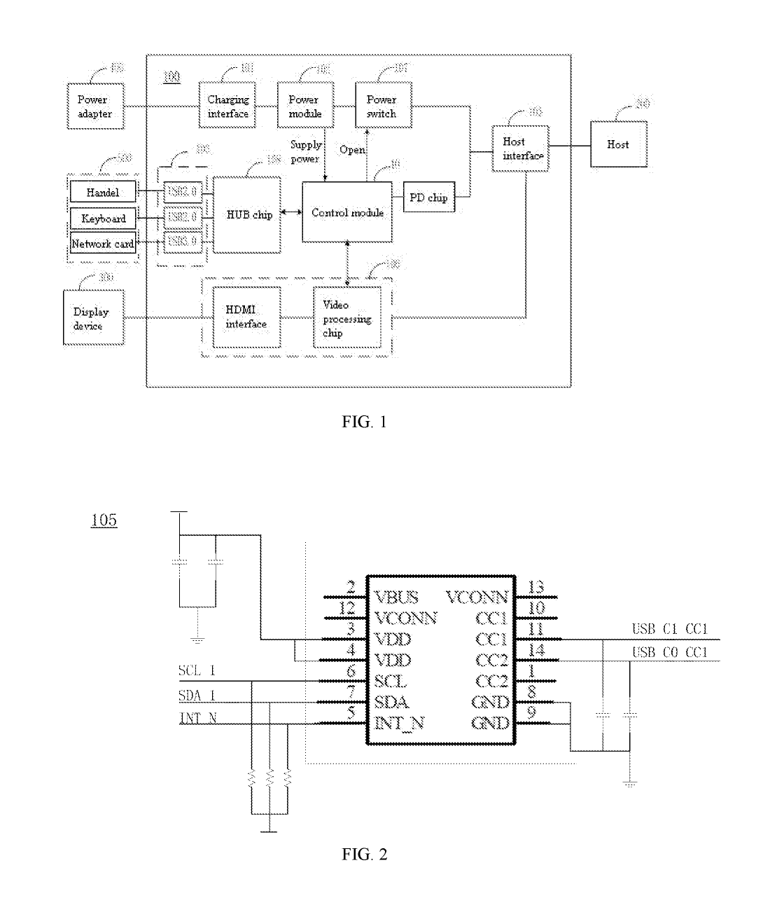

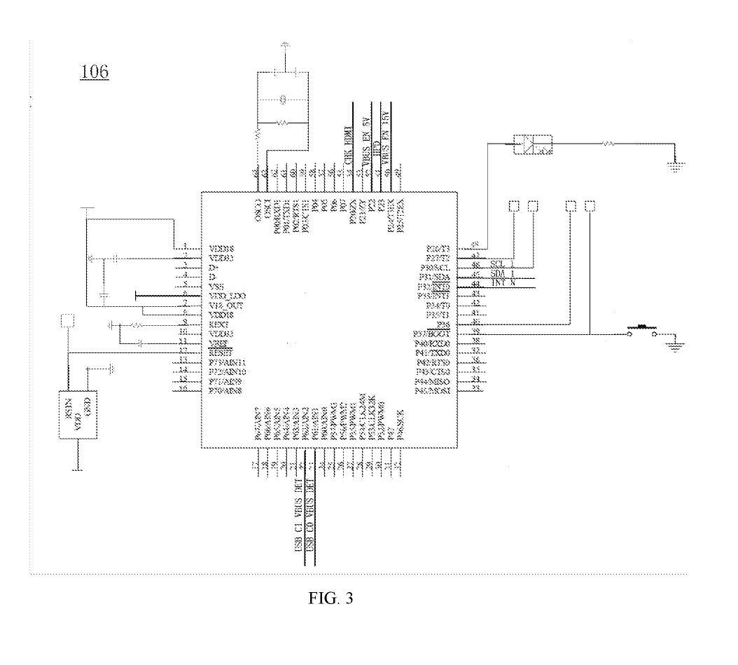

As shown in FIGS. 2-3, a PD chip 109 is connected between the control module 104 and the host 200; a P30/SCL pin as a 46th pin of the control module 104 is connected with an SCL pin as a 6th pin of the PD chip 109, a P31/SDA pin as a 45th pin of the control module 104 is connected with an SDA pin as a 7th pin of the PD chip 109, the control module 104 can intelligently identify a voltage required by the connected host 200 and charge the host 200 quickly, and at the same time the control module 104 is provided with the function of high definition video output which can be realized after the host 200 is connected with the display device 300.

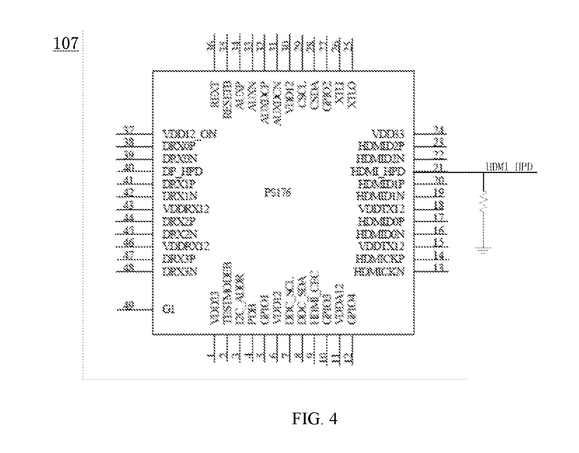

As shown in FIG. 4, the video processing chip can be a PS176 chip; the HDMI interface is connected with the display device 300, the display device 300 comprises a computer displayer, a television set, or a projector, and the HDMI interface can support an output resolution of a quality of 1080p.

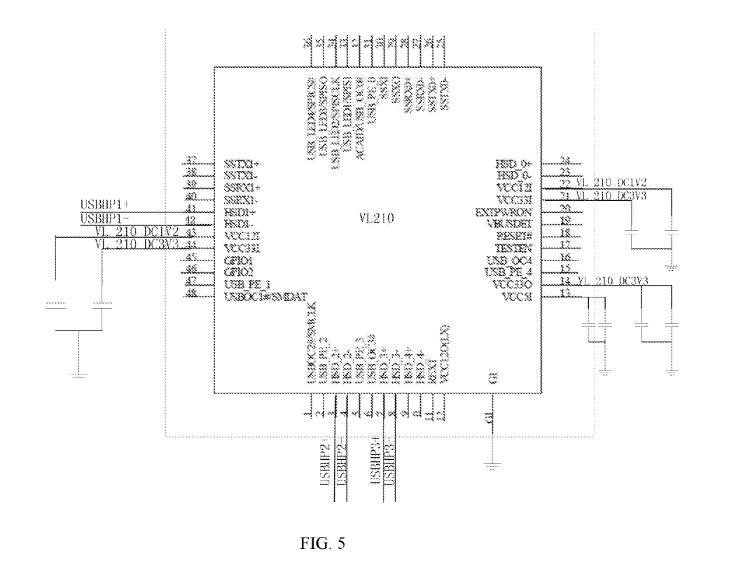

The adapter 100 further comprises the HUB chip 108, the HUB chip 108 is connected with the control module 104 and the HUB interface 103. As shown in FIG. 5, the HUB chip 108 can be a VL210 chip. As shown in FIG. 1, the HUB interface of this embodiment comprises two USB 2.0 interfaces and one USB 3.0 interface, the two USB 2.0 interfaces and the one USB 3.0 interface are used to connect with the input/output device 500, the input/output device 500 comprises a handle, a keyboard, and a network card, of which, the two USB 2.0 interfaces are respectively connected with the handle and the keyboard, and the one USB 3.0 interface is connected with the network card. The HUB interface 103 has overcurrent protection function, a data transmission velocity of the USB 3.0 interface can reach 5 Gbps at most. Different numbers of the HUB interfaces can be selected or the HUB interfaces can be connected with different external devices according to the practical needs of skilled persons in the field. This embodiment is only an example of the present application, specific number and type of the HUB interface and specific type of the externally connected device thereof should not be deemed as limitations of the present application.

As shown in FIG. 7, a first resistance R1 and a second resistance R2 are connected between the video processing chip and the control module 106; a first end of the first resistance R1 is connected with a HDMI_HPD pin for device insertion detection as a 21th pin of the video processing chip and the HDMI interface, a second end of the first resistance R1 is connected with a first end of the second resistance R2, a public connection end of the first resistance R1 and the second resistance R2 is connected with a P20/ZX as a 54th pin of the control module 104, and a second end of the second resistance R2 is grounded.

The HDMI_HPD pin for device insertion detection as the 21th pin of the video processing chip is used to detect whether the display device 300 is connected in the HDMI interface, when the display device 300 is connected in an HPD pin as a 19th pin of the HDMI interface, HDMI_HPD pin for device insertion detection as the 21th pin of the video processing chip outputs at a high level, at this moment, the public connection end of the first resistance R1 and the second resistance R2 is at the high level, the P20/ZX as the 54th pin of the control module 104 receives a high level signal, at this moment, the high level signal reaches a preset voltage value, the host 200 does not output a display picture, the display device 300 outputs the display picture, that is, when the external display device 300 is connected in, the host 200 does not output the display picture, a video signal of the host 200 is output to the screen of the display device 300 via the adapter 100 to directly enter a TV mode; and when the external display device 300 is not connected in, even the host 200 is connected into the host interface 105, the host 200 still outputs the display picture, the picture is directly output on the screen of the host 200 to enter a desktop mode, during which, it is neither required to shut down the power supply nor exit the program, so that the control module 104 controls the display states of the host 200 and the display device 300 according to the state of the pin for device insertion detection, and the seamless switch between the screen of the host 200 and the screen of the externally connected display device 300 is realized.

A power switch 107 is connected between the power module 107 and the host 200, the power switch 107 controls the power module 102 to energize/deenergize the host 200 upon receiving a level signal output from the control module 104. When the host 200 is not connected in, the power switch 107 is disconnected, and when the control module 104 detects that the host 200 is connected in, the control module 104 outputs a high level signal to the power switch 107 to conduct the power switch 107, thereby realizing the charging of the host 200 by the power module 201.

The host 200 comprises a gaming device, the gaming device can be a Nintendo Switch host or products of similar types, the gaming device of the Nintendo Switch host has a Type-C plug, the host interface 105 of the adapter 100 in a preferred embodiment of the present application is the Type-C interface, the Type-C plug of the gaming device of the Nintendo Switch host can be connected with the host interface 105 of the preferred embodiment of the present application, the adapter adopts a structure of a chassis, when the Nintendo Switch host is inserted to the host interface 105 of the adapter 100, the structure of the adapter 100 will not cover the main screen or the rear casing of the Nintendo Switch host, the user can use the handle compatible with the Nintendo Switch host or use the externally connected handle and keyboard that are externally connect with the input/output device 500 to operate the interface of the Nintendo Switch host, the screen of the host 200 will not scraped, the heat dissipation effect is good. In addition, the USB 3.0 interface of the adapter is wiredly connected with the network card, and an RJ45 Giga-bit network port is adopted, which have the advantages different from the wireless connection, such as wife, so that no delay or jammed screen will occur when using the host 200 to operate large-scale games.

By adopting the above-described adapter 100, the game interface of the host 200 is output to the display device via an HDMI line to realize the display of the game interface on the large screen, so that the handheld games are no longer limited on the interface of the handled gaming machine, besides, externally connected devices, such as the handle, the keyboard, and so on, are connected on the adapter 100 to combine the conventional gaming devices with the handheld games, the handled gaming machine is controlled, for example, by the handle, and at the same time the function of charging the host 200 is realized. In addition, in the absence of the externally connected display device, when the host 200 is inserted in the adapter 100, the screen of the host 200 still output pictures, at this moment, the host 200 is fixed on the adapter 100, the adapter 100 functions as a charging stand, a certain angle is formed between the screen of the host 200 and the horizontal plan, at the same time when the host 200 is charged, the user can use the handle compatible with the host 200 to perform wireless operations on the game of the host 200 or use the handle or keyboard that is externally connected via the HUB interface to operate the game of the host 200. Furthermore, the adapter 100 is in the structure of the chassis, when the host 200 is inserted in the host interface 105 of the adapter 100, the structure of the adapter 100 will not cover the main screen and the rear casing of the host, the screen of the host 200 will not be scraped when the user connects the host 200 in the adapter 100, and the heat dissipation effect is good. The adapter is wiredly connected with the network card, and the RJ45 Giga-bit network port is adopted, so that no delay or jammed screen will occur when using the host 200 to operate large-scale games. Thus the user's game experience is greatly improved.

The aforementioned embodiments are only preferred embodiments of the present application, and are not intended to limit the present application. Any modification, equivalent replacement, improvement, and so on, which are made within the spirit and the principle of the present application, should be included in the protection scope of the present application.

What is claimed is:

1. An adapter, configured to connect a host with a display device, comprising:
a charging interface, a power module configured to supply power, a HUB interface, a control module, a host interface, and a high definition multimedia interface (HDMI) module; wherein,
the charging interface is connected with the power module, the charging interface is capable of externally connecting with a power adapter to charge the host;
the HUB interface is connected with the host interface and an input/output device;
the host interface is configured to externally connect with the host; and
the HDMI module comprises a video processing chip and an HDMI interface, the video processing chip is connected with the control module, the HDMI interface, and the host interface; the HDMI interface is connected with the display device, and the control module controls display states of the host and the display device according to a connection state of the display device.

2. The adapter of claim 1, wherein the video processing chip comprises a device insertion detection pin configured to detect whether the display device is connected in the HDMI interface, the device insertion detection pin is connected with the HDMI interface and the control module, the control module controls the display states of the host and the display device according to a state of the device insertion detection pin.

3. The adapter of claim 2, wherein a first resistance and a second resistance are connected between the video processing chip and the control module; and
a first end of the first resistance is connected with the device insertion detection pin and the HDMI interface, a second end of the first resistance is connected with a first end of the second resistance, a public connection end of the first resistance and the second resistance is connected with the control module, and a second end of the second resistance is grounded.

4. The adapter of claim 1, wherein the charging interface is a Type-C interface.

5. The adapter of claim 1, wherein the control module is a microcontroller.

6. The adapter of claim 1, wherein a power switch is connected between the power module and the host interface, the power switch controls the power module to energize/deenergize the host upon receiving a level signal output from the control module.

7. The adapter of claim 1, further comprising a HUB chip, wherein the HUB chip is connected with the power module, the control module, and the HUB interface.

8. The adapter of claim 1, wherein the HUB interface comprises a USB 2.0 interface and/or a USB 3.0 interface.

9. The adapter of claim 1, wherein the input/output device comprises a handle, a keyboard, and a network card.

10. The adapter of claim 1, wherein the display device comprises a displayer, a television set, or a projector.
